(19) United States
(12) Patent Application Publication
(10) Pub. No.: US 2025/0199729 A1
(43) Pub. Date: Jun. 19, 2025

(54) MANAGEMENT APPARATUS CAPABLE OF EASILY PROVIDING PSA TO CLIENT APPARATUS USED BY USER WHO IS NOT ABLE TO ACCESS ONLINE STORE, CONTROL METHOD, AND STORAGE MEDIUM

(71) Applicant: CANON KABUSHIKI KAISHA, Tokyo (JP)

(72) Inventor: HIDEKI SUGIYAMA, Kanagawa (JP)

(21) Appl. No.: 18/969,385

(22) Filed: Dec. 5, 2024

(30) Foreign Application Priority Data
Dec. 18, 2023 (JP) 2023-212913

(51) Int. Cl. G06F 3/12

(52) U.S. Cl. CPC G06F 3/1225; G06F 3/1204

(57) ABSTRACT

A mechanism capable of easily providing a PSA to a client apparatus used by a user who is not able to access an online store is provided. A management apparatus that executes software for managing a printer via a network, the management apparatus includes at least one processor, and a memory coupled to the processor storing instructions that, when executed by the processor, cause the processor to function as a providing unit that provides a setting screen for constructing an application management server on the network, and a registering unit that registers an installer in the application management server in accordance with settings made on the setting screen. The installer is an installer for an application for extending an in-box driver that has been installed in a client apparatus to use the printer, and the client apparatus downloads the installer from the application management server.

### BACKGROUND OF THE INVENTION

### Field of the Invention

The present invention relates to a management apparatus, a control method, and a storage medium.

### Description of the Related Art

A configuration in which print data is transmitted to a printing apparatus by using a printer driver has been generally known. An operating system (an OS), which is basic software, has been installed in a client apparatus such as a personal computer (a PC) used by a user, and a printer driver is configured according to a print architecture defined by the OS and is called up by the OS to operate. A vendor that provides a printing apparatus provides a printer driver that conforms to the specifications of the OS. The OS and the printer driver work together to realize a function of performing printing by using the printing apparatus that is the output destination.

In recent years, the security of printer drivers has become important, and the extensibility of printer drivers themselves has become lower than that of conventional printer drivers. In order to compensate for such a decline in the extensibility, the vendor that provides the printing apparatus is able to provide a dedicated application to assist the functions of the printer driver, which is an in-box driver. Such an application is referred to as a printer support application (a PSA). By using a PSA, it is possible to enhance the printing experience for a Windows user.

Incidentally, Japanese Laid-Open Patent Publication (kokai) No. 2014-63450 has proposed a technique that provides software to a client apparatus used by a user. In the technique disclosed in Japanese Laid-Open Patent Publication (kokai) No. 2014-63450, a distribution server provides the software to the client apparatus used by the user. In addition, there is also a technique that constructs a printer driver distribution server for providing a printer driver to a client apparatus used by a user.

On the other hand, as a method for providing a PSA to a client apparatus used by a user, a common method is to download the PSA to the client apparatus from an online store run by Microsoft. However, depending on the user's environment, the online store may not be accessible. Reasons for not being able to access the online store include, for example, not having an account that is able to access the online store, and restrictions on access to the Internet imposed on a corporate network or the like. In addition, in the corporate network, only applications approved by an information security department may be made available. In such an environment, it is not possible to easily provide a PSA to a client apparatus used by a user.

### SUMMARY OF THE INVENTION

The present invention provides a mechanism capable of easily providing a PSA to a client apparatus used by a user who is not able to access an online store.

Accordingly, the present invention provides a management apparatus that executes software for managing a printer via a network, the management apparatus comprising at least one processor, and a memory coupled to the processor storing instructions that, when executed by the processor, cause the processor to function as a providing unit that provides a setting screen for constructing an application management server on the network, and a registering unit that registers an installer in the application management server in accordance with settings made on the setting screen. The installer is an installer for an application for extending an in-box driver that has been installed in a client apparatus to use the printer, and the client apparatus downloads the installer from the application management server.

According to the present invention, it is possible to easily provide the PSA to the client apparatus used by the user who is not able to access the online store.

Further features of the present invention will become apparent from the following description of exemplary embodiments with reference to the attached drawings.

### BRIEF DESCRIPTION OF THE DRAWINGS

FIG. 1 is a diagram that shows a configuration of a printing system including a management PC as a management apparatus according to an embodiment of the present invention.

FIG. 2 is a block diagram that shows a functional configuration of the printing system shown in FIG. 1.

FIG. 3 is a block diagram that schematically shows hardware configurations of the management PC and a local printer that are shown in FIG. 1.

FIG. 4 is a diagram that shows an example of a print management screen displayed on a display unit of the management PC shown in FIG. 3.

FIG. 5 is a sequence diagram that shows the procedure of a registration processing of an installer for an application executed in the printing system shown in FIG. 1.

FIG. 6 is a sequence diagram that shows the procedure of an installation control processing executed in the printing system shown in FIG. 1.

FIG. 7 is a diagram that shows an example of extended setup information shown in FIG. 2.

FIG. 8 is a flowchart that shows the procedure of a printer registration control processing executed by a client PC shown in FIG. 1.

FIG. 9 is a flowchart that shows the procedure of a print control processing executed by the client PC shown in FIG. 1.

FIG. 10 is a diagram that shows an example of a simple print setting dialog displayed on a display unit of the client PC in the embodiment of the present invention.

FIG. 11A and FIG. 11B are diagrams that show an example of a standard detailed print setting dialog displayed on the display unit of the client PC in the embodiment of the present invention.

FIG. 12A and FIG. 12B are diagrams that show an example of an extended detailed print setting dialog displayed on the display unit of the client PC in the embodiment of the present invention.

FIG. 13 is a block diagram that shows a functional configuration of a printing system that performs control that changes the configuration of the extended detailed print setting dialog.

FIG. 14 is a diagram that shows an example of a setting value file shown in FIG. 13.

FIG. 15 is a diagram that shows another example of the extended detailed print setting dialog displayed on the display unit of the client PC in the embodiment of the present invention.

FIG. 16 is a sequence diagram that shows the procedure of a registration processing of an installer for an application executed in the printing system shown in FIG. 13.

FIG. 17 is a flowchart that shows the procedure of a setting value file edit processing executed in S1606 of FIG. 16.

FIG. 18 is a diagram that shows an example of a sub-dialog of the print management screen displayed on the display unit of the management PC shown in FIG. 3.

FIG. 19 is a diagram that shows an example of a setting value editing screen displayed on the display unit of the management PC shown in FIG. 3.

FIG. 20 is a diagram that shows an example of a device management screen of a management application displayed on the display unit of the management PC shown in FIG. 3.

FIG. 21A and FIG. 21B are diagrams that show another example of the sub-dialog on the print management screen shown in FIG. 4.

### DESCRIPTION OF THE EMBODIMENTS

The present invention will now be described in detail below with reference to the accompanying drawings showing embodiments thereof.

Hereinafter, a preferred embodiment of the present invention will be described with reference to the drawings.

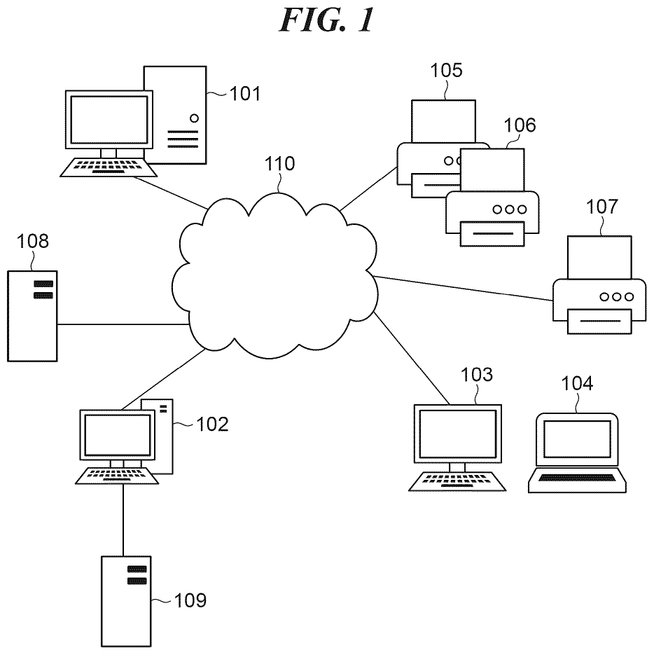

FIG. 1 is a diagram that shows a configuration of a printing system including a management PC 102 as a management apparatus according to the present embodiment. As shown in FIG. 1, the printing system includes a local application management server 101, the management PC 102, a client PC 103, a client PC 104, a local printer 105, a local printer 106, a shared printer 107, and a print server 108. The local application management server 101, the management PC 102, the client PC 103, the client PC 104, the local printer 105, the local printer 106, the shared printer 107, and the print server 108 are connected to each other via a network 110 whose range is limited, such as a local area network (a LAN). In addition, in the printing system, the management PC 102 is able to communicate with an online application management server 109 via the Internet. It should be noted that in FIG. 1, as an example, the printing system is shown to include two client PCs, but the printing system is not limited to this configuration and may include at least one client PC.

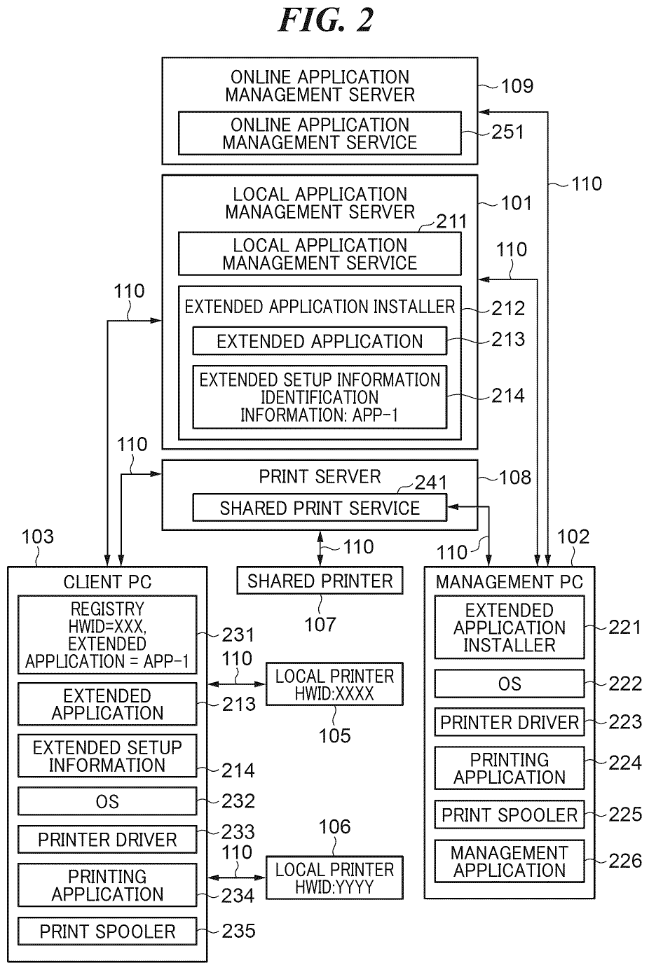

FIG. 2 is a block diagram that shows a functional configuration of the printing system shown in FIG. 1.

The local application management server 101 serving as an application management server has functions as a software distribution server. The local application management server 101 manages software to be installed in an information processing apparatus connected via the network 110, and distributes the software to the information processing apparatus. It should be noted that in the present embodiment, as an example, the local application management server 101 is described as being configured as one physical server, but the present invention is not limited to this configuration. For example, the local application management server 101 may be configured with a plurality of physical servers. Alternatively, the local application management server 101 may be a virtualized cloud server in which one or more servers are available via the Internet. The local application management server 101 includes a local application management service 211.

The local application management service 211 distributes an installer for an application to the information processing apparatus connected via the network 110. For example, the local application management service 211 distributes an extended application installer 212 to the client PC 103 in response to a request received from the client PC 103 connected via the network 110. The extended application installer 212 includes an extended application 213 and extended setup information 214 referenced by the extended application 213. The extended application 213 is a PSA, which is a dedicated application to assist the functions of a printer driver that is an in-box driver installed in the management PC 102, the client PC 103, the client PC 104, or the like.

The management PC 102 and the client PC 103 are capable of executing various kinds of programs such as application programs, and are equipped with a printer driver having a function of converting print data into a printer language compatible with the printer. In addition, the management PC 102 and the client PC 103 are capable of bidirectionally communicating with other apparatuses connected to the network 110. The printer driver supports multiple types of printers, for example, supports all of the local printer 105, the local printer 106, and the shared printer 107.

The management PC 102 is an information processing apparatus such as a personal computer, a tablet terminal, or a smartphone, and is a terminal that is directly operated by a user who has administrator authority for this printing system (hereinafter, referred to as “an administrative user”). It should be noted that the management PC 102 is also able to have functions as a client. The management PC 102 is connected to the network 110 by a network cable such as Ethernet (registered trademark). The management PC 102 monitors the statuses of other apparatuses connected to the network 110 and performs various kinds of settings. On the management PC 102, any application software is capable of being executed. The management PC 102 includes an operating system (an OS) 222, a printer driver 223, a printing application 224, and a print spooler 225 as basic software. Furthermore, the management PC 102 includes an extended application installer 221 and a management application 226. In the present embodiment, the administrative user is able to operate the management PC 102 to obtain the extended application installer 212 or the like from the online application management server 109. In addition, the administrative user is able to store the obtained extended application installer 212 in the local application management server 101 by using the management application 226.

Each of the client PC 103 and the client PC 104 is an information processing apparatus such as a personal computer, a tablet terminal, or a smartphone, and is a terminal that is directly operated by a user who does not have the above-described administrator authority (hereinafter, simply referred to as “a user”). It should be noted that in the present embodiment, the client PC 103 and the client PC 104 have the same functional configuration, and the functional configuration of the client PC 103 will be described below as an example.

On the client PC 103, any application software is capable of being executed. The client PC 103 includes a registry 231. In addition, the client PC 103 includes an OS 232, a printer driver 233, a printing application 234, and a print spooler 235 as basic software. Furthermore, the client PC 103 includes the extended application 213 and the extended setup information 214 that are included in the extended application installer 212 that has been obtained from the local application management service 211. When the user issues a print instruction by using the printing application 234, the printer driver 233 generates print data and passes (transmits) the print data to the print spooler 235. The print spooler 235 queues the received print data as a print job, and transmits the print job to a printer designated by the user from among the local printer 105, the local printer 106, and the shared printer 107.

The registry 231 is an area of a registry database in which a plurality of setting values related to the OS 232 have been described. The registry 231 is able to describe (store) values by using the key and value method. In addition, a correspondence relationship between an identifier of the extended application 213 and an HWID of the local printer supported by the extended application 213 is registered in the registry 231. The HWID is an identifier that is different for each type or model of printer, and is identification information used to identify the type of printer.

The shared printer 107, the local printer 105, and the local printer 106 are all image forming apparatuses (including printers, copiers, multifunctional peripherals, etc.), and each of the shared printer 107, the local printer 105, and the local printer 106 is connected to the network 110 via a network interface (not shown). The shared printer 107, the local printer 105, and the local printer 106 perform printing based on print jobs transmitted from the client PC 103, the client PC 104, and the like. It should be noted that each of the local printer 105, the local printer 106, and the shared printer 107 may be any one of a variety of printers such as a laser beam printer employing an electrophotographic system, an inkjet printer employing an inkjet system, and a printer using a thermal transfer system. It should be noted that the local printer 105 and the local printer 106 have the identification information (the HWID) “XXXX” and “YYYY”, respectively.

The print server 108 includes a shared print service 241. The print server 108 accepts (receives) a print instruction and print data from outside. In addition, the print server 108 transmits the received print data to the shared printer 107 via the shared print service 241.

The online application management server 109 is a server that has functions as a software distribution server, and includes an online application management service 251. The software to be distributed includes applications, drivers, security patches, etc. The online application management service 251 receives a request to distribute an application via the Internet, and distributes an installer for the application corresponding to this distribution request. It should be noted that in the present embodiment, the management PC 102 is permitted to access the online application management server 109 and is capable of directly obtaining the extended application installer 212 and the like from the online application management server 109. On the other hand, the client PC 103 and the client PC 104 are not permitted to access the online application management server 109 and are therefore unable to directly obtain the extended application installer 212 and the like from the online application management server 109.

Next, the hardware configurations of the information processing apparatuses and the image forming apparatuses in the printing system shown in FIG. 1 will be described. It should be noted that in the present embodiment, the management PC 102, the client PC 103, and the client PC 104 that serve as the information processing apparatuses in the printing system shown in FIG. 1 all have the same hardware configuration, and the hardware configuration will be described below by using the management PC 102 as an example. In addition, the local printer 105, the local printer 106, and the shared printer 107 that serve as the image forming apparatuses in the printing system shown in FIG. 1 all have the same hardware configuration, and the hardware configuration will be described below by using the local printer 105 as an example.

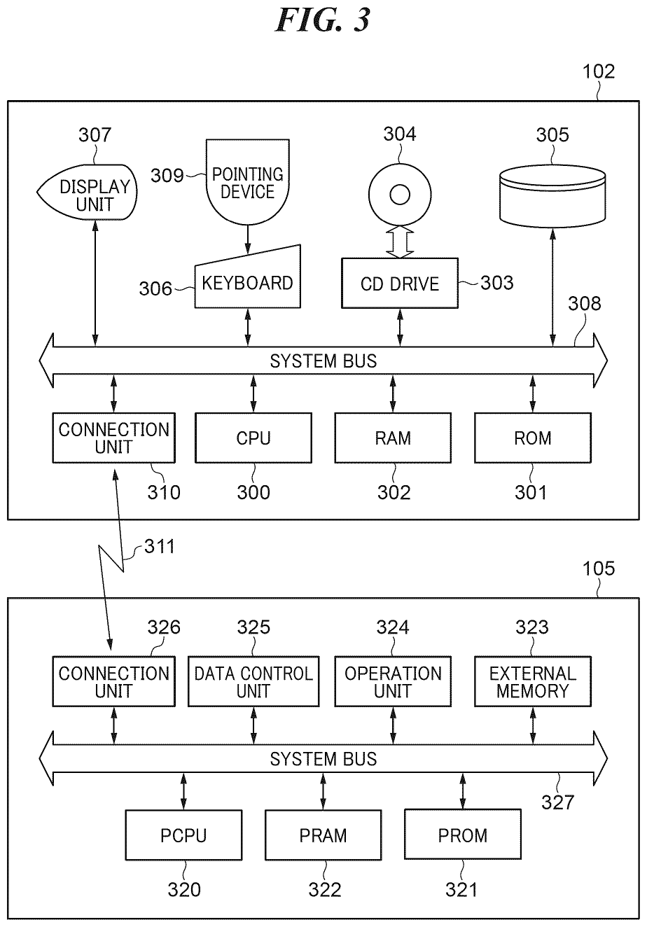

FIG. 3 is a block diagram that schematically shows the hardware configurations of the management PC 102 and the local printer 105 that are shown in FIG. 1.

First, the hardware configuration of the management PC 102 will be described. As shown in FIG. 3, the management PC 102 includes a central processing unit (a CPU) 300, a read only memory (a ROM) 301, a random access memory (a RAM) 302, a CD drive 303, a storage unit 305, a keyboard 306, a display unit 307, a pointing device 309, and a connection unit 310. The CPU 300, the ROM 301, the RAM 302, the CD drive 303, the storage unit 305, the keyboard 306, the display unit 307, and the connection unit 310 are connected to one another via a system bus 308.

The CPU 300 executes application programs, printer driver programs, the OS, a network printer control program, and the like, which have been stored in the storage unit 305. In addition, the CPU 300 performs control to temporarily store, in the RAM 302, information, files, and the like required for executing the programs.

The ROM 301 stores programs such as basic I/O programs, and various kinds of data such as font data and template data that are used in document processing. The RAM 302 is a temporary storage means and functions as a main memory, a working area, etc. for the CPU 300. The CD drive 303 is an optical disk CD drive that reads a storage medium 304 such as a CD-ROM. It should be noted that the storage medium 304 is not limited to a CD-ROM, but may be a CD-R, a CD-RW, a PC card, a DVD, a memory card, an MO, or the like. The storage medium 304 stores computer-readable programs.

The storage unit 305 is a storage device that functions as a large-capacity memory, and for example, is a hard disk drive (an HDD). The storage unit 305 stores the application programs, the printer driver programs, the OS, control programs, related programs, etc.

The keyboard 306 and the pointing device 309 are used to input user instructions. The display unit 307 displays various kinds of information such as the status of the printer in accordance with the instruction inputted via the keyboard 306. The connection unit 310 transmits and receives data to and from external apparatuses such as the local printer 105 via a bidirectional interface 311.

Next, the hardware configuration of the local printer 105 will be described. As shown in FIG. 3, the local printer 105 includes a PCPU 320, a PROM 321, a PRAM 322, an external memory 323, an operation unit 324, a data control unit 325, and a connection unit 326. The PCPU 320, the PROM 321, the PRAM 322, the external memory 323, the operation unit 324, the data control unit 325, and the connection unit 326 are connected to one another via a system bus 327.

The PCPU 320 is a printer CPU (a CPU of the local printer 105), and is responsible for the overall control of the local printer 105 (performs the overall control of the local printer 105). The PCPU 320 transmits image signals to the data control unit 325 based on a control program that has been stored in the PROM 321 or the external memory 323 and a printer control command received by the connection unit 326.

The PROM 321 is an internal memory of the local printer 105, and like the external memory, stores various kinds of data, the control program for controlling the local printer 105, etc. The PRAM 322 functions as a main memory for the PCPU 320. In addition, the PRAM 322 functions as a work data area for temporarily storing various kinds of data when the PCPU 320 is executing control. The external memory 323 is connected as an option of the local printer 105 and stores font data, emulation programs, form data, etc.

The operation unit 324 includes an input unit including an operation panel and/or operation switches, a display unit including light-emitting diodes (LEDs) and/or a liquid crystal panel, and the like, and receives operations from an operator (the user) and displays various kinds of information. The operator (the user) is able to confirm, for example, various kinds of settings and the like in the local printer 105 via the operation unit 324. The data control unit 325 is a printer engine and is controlled by the PCPU 320. The data control unit 325 performs a printing processing based on the image signals outputted from the PCPU 320. The connection unit 326 is connected to, for example, the connection unit 310 of the management PC 102 via the bidirectional interface 311.

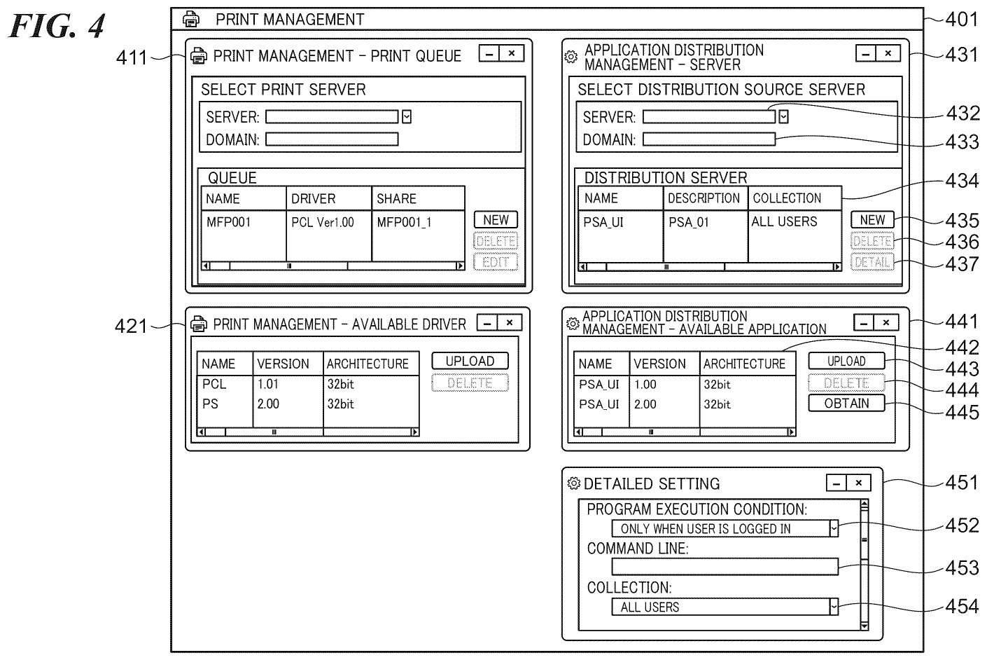

FIG. 4 is a diagram that shows an example of a print management screen 401 displayed on the display unit 307 of the management PC 102 shown in FIG. 3.

The print management screen 401 is a screen for performing various kinds of settings related to the printing system shown in FIG. 1. In the present embodiment, the administrative user is able to perform, for example, an operation of registering an application to be installed in the information processing apparatus connected to the network 110 from the print management screen 401 displayed on the display unit 307 of the management PC 102.

The print management screen 401 includes sub-dialogs 411, 421, 431, 441, and 451. On the print management screen 401, common functions of the sub-dialogs include hiding, redisplaying, minimizing, and maximizing the sub-dialogs.

On the sub-dialog 411, it is possible to perform designating a print server, and registering or deleting a print queue with respect to the designated print server.

On the sub-dialog 421, it is possible to issue an instruction for uploading a printer driver to the designated print server.

On the sub-dialog 431, it is possible to perform designating a software distribution server and confirming software that has already been registered in the designated software distribution server. The sub-dialog 431 includes controls 432, 433, 434, 435, 436, and 437.

By using the control 432, a server name of the software distribution server is designated. By using the control 433, a domain name, to which the software distribution server designated by the control 432 belongs, is designated. By using the control 434, it is possible to display a list of a name, a description, and a collection of software that has already been registered in the software distribution server designated by the control 432. It should be noted that the collection is capable of being designated on the sub-dialog 451, which will be described below.

On the sub-dialog 431, for example, when the administrative user presses the control 435, a dialog (not shown) is displayed on the display unit 307, and the administrative user is able to use this dialog to newly register a software distribution server. In addition, when the administrative user presses the control 436 while the software information displayed on the control 434 has been selected, it is possible to delete the software corresponding to the selected information. In addition, when the administrative user presses the control 437 while the software information displayed on the control 434 has been selected, it is possible to display detailed information on the software corresponding to the selected information.

On the sub-dialog 441, it is possible to register applications in the software distribution server. The sub-dialog 441 includes controls 442, 443, 444, and 445. By using the control 442, a list of applications that are capable of being registered in the software distribution server is displayed. For example, a list of applications that have already been stored in the management PC 102 is displayed on the control 442 along with their detailed information.

On the sub-dialog 441, for example, when the administrative user presses the control 443 while the application information displayed on the control 442 has been selected, an installer for the selected application is registered in the software distribution server. In addition, when the administrative user presses the control 444 while the application information displayed on the control 442 has been selected, the selected application's information is deleted from the control 442. In addition, when the administrative user presses the control 445, a dialog (not shown) is displayed on the display unit 307 of the management PC 102, and the administrative user is able to use this dialog to newly obtain an application. For example, the management PC 102 is connected to the online application management server 109 and requests a list of obtainable applications (available applications). The management PC 102 downloads from the online application management server 109 an installer for the application designated by the administrative user from this list, and stores the downloaded installer in a predetermined storage location.

On the sub-dialog 451, it is possible to perform various kinds of detailed settings for distribution. The sub-dialog 451 includes controls 452, 453, and 454.

By using the control 452, a program execution condition is designated. For example, when “only when user is logged in” is selected on the control 452, in the case that the user is logged in to a client PC which is the distribution destination, an installer for an application to be distributed is distributed to the client PC which is the distribution destination.

By using the control 453, an argument to be passed to the installer for the application to be distributed is designated. For example, when “-Silent” is designated on the control 453, the installer for the application to be distributed is called with the argument “-Silent”, and the installation processing of this installer is executed without a user interface (a UI) or the like that instructs the start of installation being displayed on the display unit 307.

By using the control 454, a user, a group, or a client apparatus, to which the application to be distributed is capable of being distributed, is designated. It should be noted that on the sub-dialog 451, by using a control (not shown), it is also possible to designate a time when the distribution of the application to be distributed will start, a distribution exclusion time that is a time when the distribution will not be performed, etc.

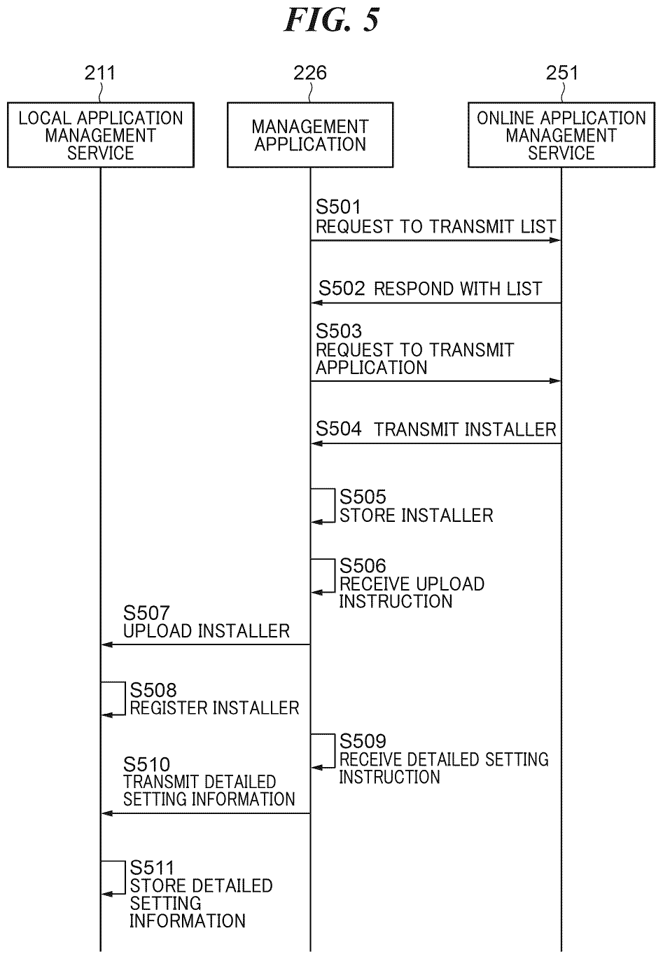

FIG. 5 is a sequence diagram that shows the procedure of a registration processing of an installer for an application executed in the printing system shown in FIG. 1. The registration processing shown in FIG. 5 is performed by the local application management server 101, the management PC 102, and the online application management server 109. The registration processing shown in FIG. 5 is executed, for example, when the administrative user has pressed the control 445 on the print management screen 401 displayed on the display unit 307. When the control 445 is pressed, the management PC 102 accesses the online application management server 109.

As shown in FIG. 5, first, the management application 226 of the management PC 102 makes (transmits), to the online application management service 251 of the online application management server 109, a request to transmit a list of applications whose services have already been published (S501).

The online application management service 251, which has received the request to transmit the list of applications whose services have already been published, responds to the management application 226 with the list of applications whose services have already been published (S502).

In the management PC 102, a dialog (not shown), which allows the administrative user to designate applications to be obtained based on the received list of applications whose services have already been published, is displayed on the display unit 307. The management application 226 makes (transmits), to the online application management service 251, a request to transmit an application designated by the administrative user on this dialog (S503).

The online application management service 251 transmits an installer for the application indicated by this transmission request, for example, the extended application installer 221, to the management application 226 (S504).

The management application 226 stores the received installer, for example, the extended application installer 221, in a storage area secured in advance in the management PC 102, such as the storage unit 305 (S505). In addition, the management application 226 additionally displays information about the application corresponding to the stored installer on the control 442 of the print management screen 401 that has been displayed on the display unit 307.

Thereafter, when the management application 226 receives an application upload instruction such that when the administrative user presses the control 443 on the print management screen 401 (S506), the management application 226 takes out the installer for the application designated by the administrative user from the above storage area. The management application 226 uploads (transmits), to the local application management service 211, the installer that has been taken out (S507). For example, the management application 226 takes out the extended application installer 221 from the above storage area, and uploads, to the local application management service 211, the extended application installer 221 that has been taken out. It should be noted that the management application 226 may edit the extended application installer that has been taken out from the above storage area and upload the edited extended application installer to the local application management service 211. In the present embodiment, it is assumed that the extended application installer that has been uploaded from the management application 226 to the local application management service 211 is the extended application installer 212.

In addition, the management application 226 additionally displays information about the application corresponding to the uploaded installer on the control 434. For example, the name of this application is displayed on the “name” field in the control 434, and information about this application is displayed on the “description” field in the control 434. In addition, the value designated by the control 454 on the sub-dialog 451 is displayed on the “collection” field in the control 434. It should be noted that in the case that the information to be displayed on these fields has not been set, a blank space or a default value will be displayed on each of these fields.

The local application management service 211 registers the installer that has been transmitted in S507 (S508). Specifically, the local application management service 211 stores, in a storage area secured in advance in the local application management server 101, the installer that has been transmitted in S507.

On the other hand, in the management PC 102, when the management application 226 receives a detailed setting instruction such that when the administrative user presses the control 437 (S509), the management application 226 takes out detailed setting information that has been designated by the administrative user on the sub-dialog 451 or the like. The management application 226 transmits, to the local application management service 211, the detailed setting information that has been taken out (S510).

The local application management service 211 stores, in the storage area secured in advance in the local application management server 101, the detailed setting information that has been transmitted in S510 (S511), and the registration processing shown in FIG. 5 ends.

Next, in the printing system of the present embodiment, an installation control processing for installing the extended application 213 in the client PC 103 and the client PC 104 that are not permitted to access the online application management server 109 will be described. Hereinafter, as an example, a processing of installing the extended application 213 in the client PC 103 out of the client PC 103 and the client PC 104 will be described.

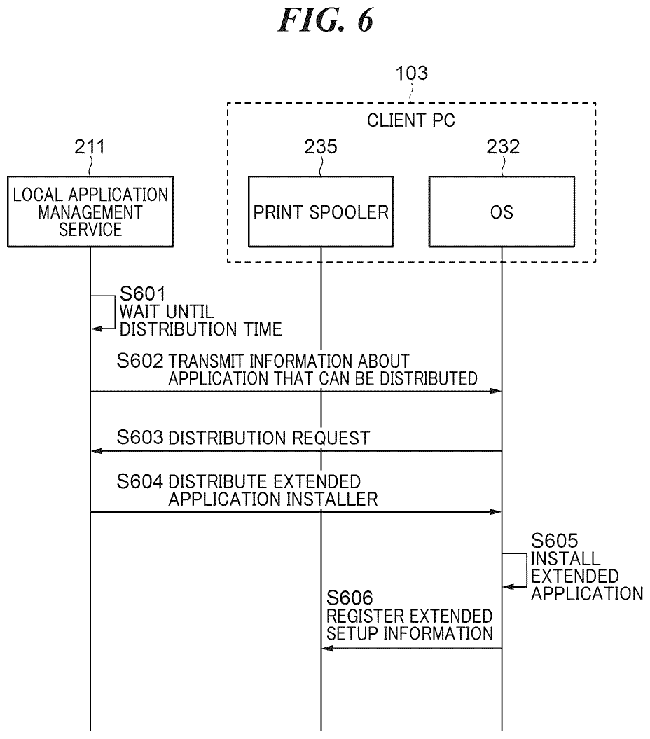

FIG. 6 is a sequence diagram that shows the procedure of the installation control processing executed in the printing system shown in FIG. 1. The installation control processing shown in FIG. 6 is executed by the client PC 103 and the local application management server 101. It should be noted that in the installation control processing shown in FIG. 6, it is assumed that the extended application installer 212 transmitted from the management PC 102 in the above-described registration processing and the detailed setting information set on the sub-dialog 451 in the above-described registration processing have already been registered in the local application management service 211.

As shown in FIG. 6, first, the local application management service 211 of the local application management server 101 waits until a distribution time that has been determined based on the detailed setting information set on the sub-dialog 451 arrives (S601). When the distribution time arrives, the local application management service 211 transmits, to the OS 232 of the client PC 103, information about a distributable application (S602). Here, it is assumed that as an example of the information about the distributable application, information such as the name, the version, and the file size of the extended application 213 included in the extended application installer 212 has been transmitted.

When the OS 232 receives the information about the distributable application, the OS 232 displays, on a display unit of the client PC 103, a software installation permission dialog (not shown) for obtaining installation permission from the user of the client PC 103.

The OS 232 that has obtained the installation permission makes (transmits) a distribution request for the extended application installer 212 to the local application management service 211 (S603).

The local application management service 211 distributes the extended application installer 212, which corresponds to the distribution request received from the OS 232, to the client PC 103 (S604).

The OS 232 starts the received extended application installer 212 and installs the extended application 213 included in the extended application installer 212 in the client PC 103 (S605). In S605, for example, the OS 232 stores the extended application 213 in a predetermined storage area and appropriately sets a registry required by the extended application 213.

Next, the OS 232 registers the extended setup information 214 included in the extended application installer 212 (S606). Specifically, the OS 232 takes out the extended setup information 214 from the extended application installer 212, and stores the extended setup information 214 that has been taken out in an OS area in which a group of setting files have been stored. After that, the installation control processing shown in FIG. 6 ends.

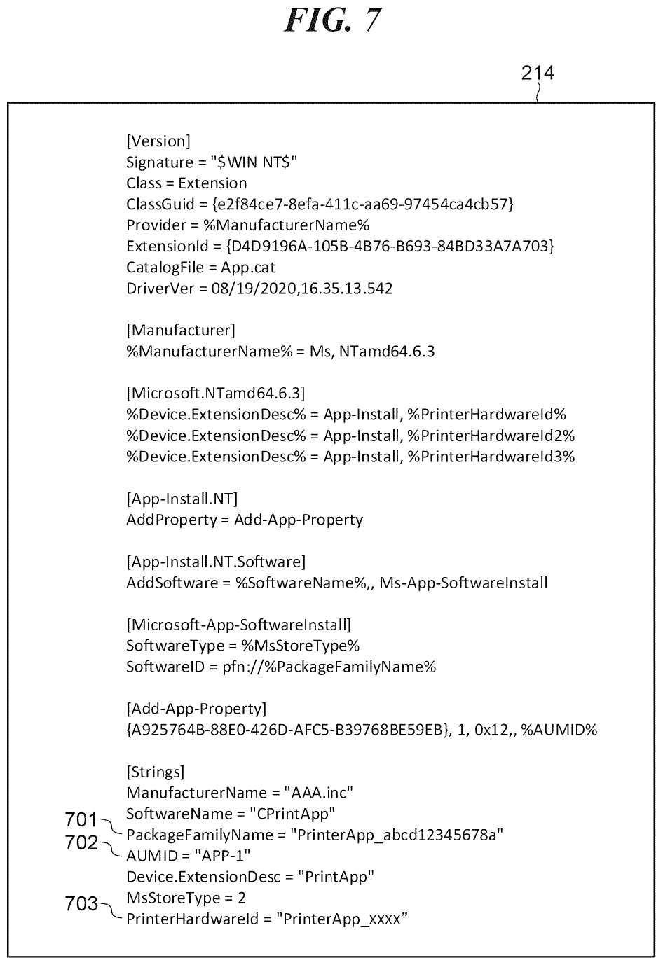

FIG. 7 is a diagram that shows an example of the extended setup information 214 shown in FIG. 2.

As shown in FIG. 7, the extended setup information 214 describes information for identifying the extended application 213 to be associated with a printer queue.

In the example shown in FIG. 7, a name that identifies the extended application 213 is described in PackageFamilyName 701. In addition, an ID “APP-1” that identifies the extended application 213 is described in AUMID 702. Furthermore, a character string “PrinterAPP_XXXX”, in which additional identification information “Printer_APP” has been added to the identification information (the HWID) “XXXX” of the local printer 105, is described in PrinterHardwareID 703.

Next, processing executed by the client PC 103 will be described.

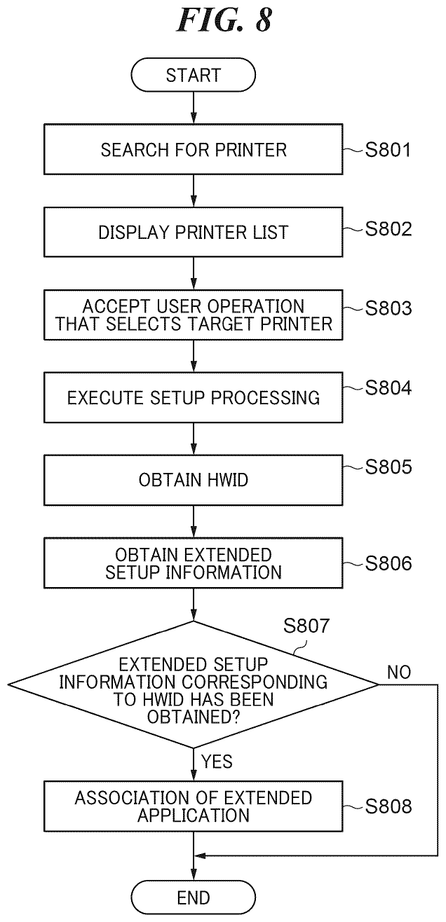

FIG. 8 is a flowchart that shows the procedure of a printer registration control processing executed by the client PC 103 shown in FIG. 1. In the printer registration control processing, a printer is registered and an extended application is associated with the printer. The printer registration control processing is executed by the OS 232.

As shown in FIG. 8, the OS 232 makes an inquiry by multi-casting to the network 110 to search for a printer compatible with the printer driver 233 (S801). For the search, for example, Bonjour, web services for devices (WSD), or the like is used.

When the OS 232 receives a response to the above inquiry, the OS 232 displays, on the display unit of the client PC 103, a printer list for selecting printers to be added based on this response (S802). Here, it is assumed that the local printer 105 and the local printer 106 have been found by the search, and information about the local printer 105 and the local printer 106 is displayed in the printer list.

Next, the OS 232 accepts a user operation that selects a target printer from the printer list (S803). Here, it is assumed that the local printer 105 has been selected.

Next, the OS 232 performs a setup processing for the printer driver 233 so that printing is capable of being performed by using the target printer that has been selected in S803 (S804). In the setup processing, the printer driver 233 is registered, a printer queue is created, and setting of the registry 231 used by the print spooler 235 and the OS 232 is performed. In addition, setting of a print port is performed, and printer driver capability setting based on print attribute information, which conforms to the Internet Printing Protocol (IPP) and has been obtained from the local printer 105 being the target printer, is performed. By executing the processes in S801 to S804, the local printer 105 becomes available from the printer driver 233.

The processing from S805 onwards is a control for extending the printer driver 233 with the extended application 213. In S805, the OS 232 obtains, from the target printer, an HWID, which is identification information for identifying the target printer. Specifically, the OS 232 obtains “XXXX”, which is the HWID of the local printer 105, from the local printer 105 which is the target printer.

Next, the OS 232 obtains the extended setup information 214 that has been stored in the client PC 103 (S806). Next, the OS 232 determines whether or not the extended setup information 214 corresponding to the HWID obtained in S805 has been obtained based on the HWID obtained in S805 (S807). For example, in the case that the value of the PrinterHardwareID 703 in the extended setup information 214 obtained in step S806 is “PrinterApp_XXXX” and the HWID is “XXXX”, it is determined that the extended setup information 214 corresponding to the HWID obtained in S805 has been obtained. In this case, the printer registration control processing proceeds to S808. In S808, the OS 232 performs association of the extended application 213. Specifically, the OS 232 registers, in the registry 231 that has been registered in S804, the value of the AUMID 702 that has been taken out from the extended setup information 214 and the HWID that has been obtained in S805. Through this registration, the local printer 105 and the extended application 213 have been associated with each other in the client PC 103. After that, the printer registration control processing ends.

On the other hand, in the case of being determined in S807 that the extended setup information 214 corresponding to the HWID obtained in S805 has not been obtained, the association of the extended application 213 will not be performed, and the printer registration control processing ends.

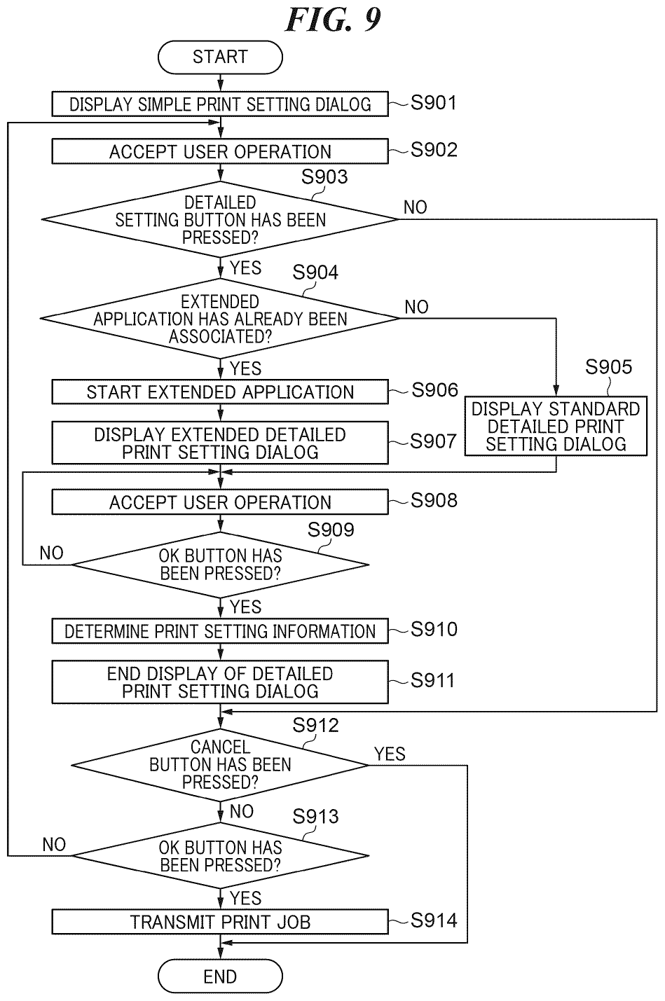

FIG. 9 is a flowchart that shows the procedure of a print control processing executed by the client PC 103 shown in FIG. 1. Similar to the printer registration control processing described above, the print control processing is also executed by the OS 232. The print control processing is started when the user designates a printer that will execute the printing processing from among the printers registered by the above-described printer registration control processing, and issues a print instruction to cause the designated printer to execute the printing processing by using the print function of the printing application 234.

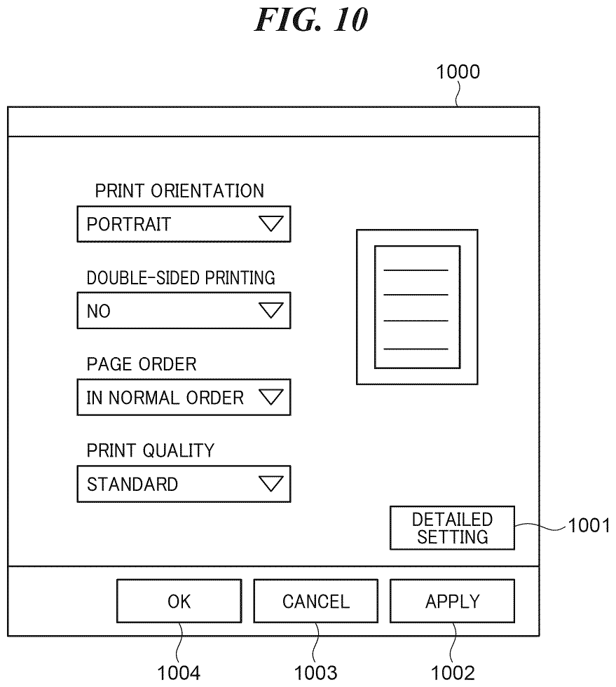

As shown in FIG. 9, first, the OS 232 causes the display unit of the client PC 103 to display a simple print setting dialog 1000 shown in FIG. 10 (S901). On the simple print setting dialog 1000, simple settings to be used for printing are performed. The simple print setting dialog 1000 includes a “detailed setting” button 1001, an “apply” button 1002, a “cancel” button 1003, and an “OK” button 1004. The “detailed setting” button 1001 is a button for instructing the display of a detailed print setting dialog, which will be described below. The “apply” button 1002 is a button for instructing saving of print settings. The “cancel” button 1003 is a button for instructing to cancel the print settings. The “OK” button 1004 is a button for instructing the start of printing.

When the OS 232 accepts a user operation on the simple print setting dialog 1000 (S902), the OS 232 determines whether or not the “detailed setting” button 1001 has been clicked (has been pressed) (S903). In the case of being determined that the “detailed setting” button 1001 has not been clicked, the print control processing proceeds to S912, which will be described below. On the other hand, in the case of being determined that the “detailed setting” button 1001 has been clicked, the print control processing proceeds to S904.

In S904, the OS 232 determines whether or not the extended application 213 has already been associated. For example, in the case that an ID for identifying the extended application 213 in association with the printer designated by the user has not been registered in the registry 231, it is determined that the extended application 213 has not been associated. In this case, the print control processing proceeds to S905.

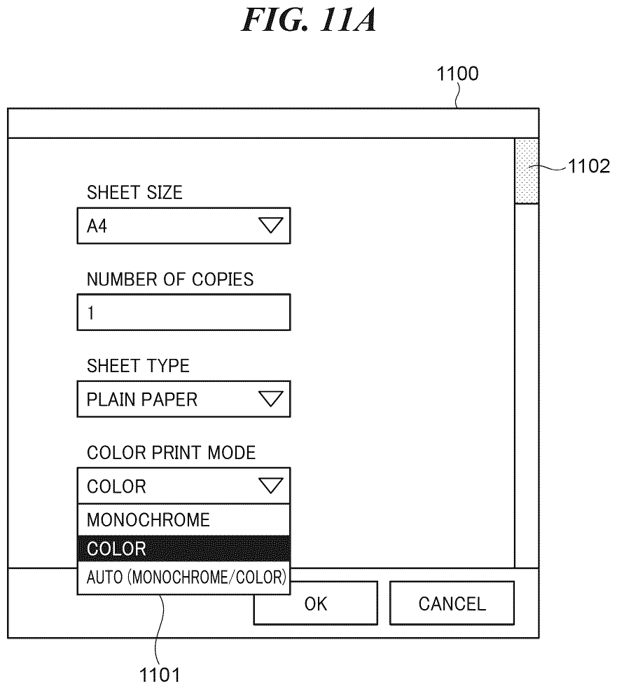

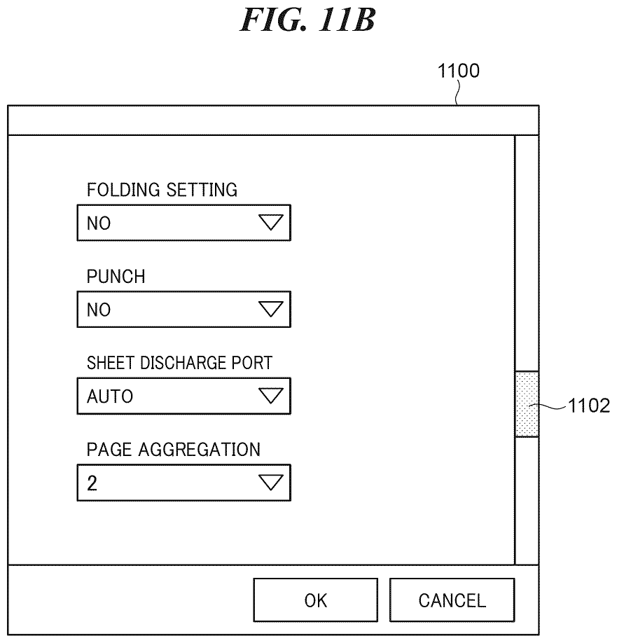

In S905, the OS 232 causes the display unit of the client PC 103 to display a standard detailed print setting dialog 1100 shown in FIG. 11A. On the standard detailed print setting dialog 1100, detailed settings to be used for printing, such as a sheet size, the number of copies, a sheet type, a color print mode, etc., are set. For example, in a color print mode 1101, the user is able to select one of “monochrome”, “color”, and “auto (monochrome/color)”, with “color” set as the default value. In addition, on the standard detailed print setting dialog 1100, the screen is capable of being scrolled by operating a scroll bar 1102, and therefore it is possible to set setting values of various kinds of print setting items. FIG. 11B shows an example in which the print setting items have been changed by moving the scroll bar 1102. In the example of FIG. 11B, as the print setting items, it is possible to set a folding setting, punching, sheet discharge port, and page aggregation. After completing the process of S905, the print control processing proceeds to S908, which will be described below.

On the other hand, in S904, for example, in the case that the ID for identifying the extended application 213 in association with the printer designated by the user has been registered in the registry 231, it is determined that the extended application 213 has already been associated. In this case, the print control processing proceeds to S906. In S906, the OS 232 starts the extended application 213 that has been associated with this printer, that is, starts the extended application 213 corresponding to the above ID.

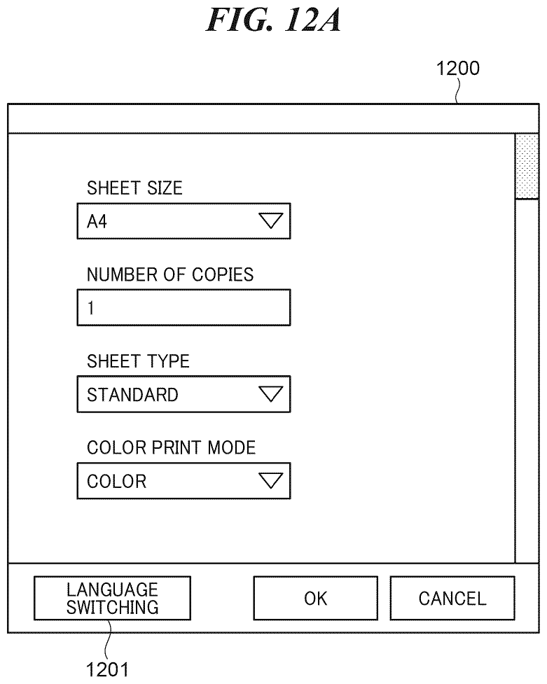

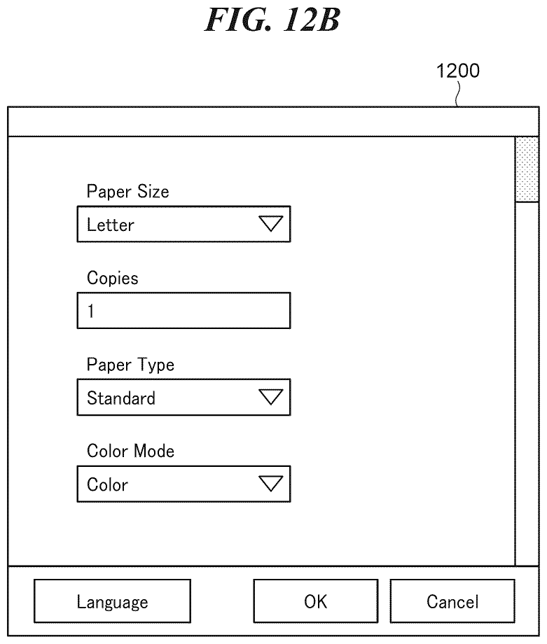

Next, the OS 232 controls the extended application 213 to cause the display unit of the client PC 103 to display an extended detailed print setting dialog 1200 shown in FIG. 12A (S907). Similar to the standard detailed print setting dialog 1100 described above, on the extended detailed print setting dialog 1200, detailed settings to be used for printing, such as a sheet size, the number of copies, a sheet type, a color print mode, etc., are set. It should be noted that the extended detailed print setting dialog 1200 includes a “language switching” button 1201 that is not included in the standard detailed print setting dialog 1100 described above. When the user presses the “language switching” button 1201, a language switching screen (not shown) is displayed on the display unit of the client PC 103. On this language switching screen, the user is able to select one of the displayed language options: Japanese, English, French, and German. For example, in the case that the user has selected “English” on this language switching screen, as shown in FIG. 12B, the language display of buttons and the like on the extended detailed print setting dialog 1200 is changed to English. In this way, the extended application 213 includes a language switching function that is not included in standard functions. It should be noted that in the present embodiment, the extended application 213 has been described as including the language switching function that is not included in the standard functions. However, the extended application 213 may include other functions in addition to the language switching function. After completing the process of S907, the print control processing proceeds to S908, which will be described below.

In S908, when the OS 232 accepts a user operation on the standard detailed print setting dialog 1100 or the extended detailed print setting dialog 1200 displayed on the display unit of the client PC 103, the print control processing proceeds to S909.

In S909, the OS 232 determines whether or not the OK button has been pressed on the standard detailed print setting dialog 1100 or the extended detailed print setting dialog 1200 displayed on the display unit of the client PC 103. In the case of being determined that the OK button has not been pressed, the print control processing returns to S908. On the other hand, in the case of being determined that the OK button has been pressed, the print control processing proceeds to S910.

In S910, the OS 232 determines the setting values that have been set on the standard detailed print setting dialog 1100 or the extended detailed print setting dialog 1200 displayed on the display unit of the client PC 103 as print setting information. Next, the OS 232 ends the display of the standard detailed print setting dialog 1100 or the extended detailed print setting dialog 1200 (S911). When the display of the standard detailed print setting dialog 1100 or the extended detailed print setting dialog 1200 is ended, the simple print setting dialog 1000 is displayed on the display unit of the client PC 103.

Next, the OS 232 determines whether or not the “cancel” button 1003 on the simple print setting dialog 1000 has been pressed (S912). In the case of being determined that the “cancel” button 1003 has been pressed, the print control processing ends. On the other hand, in the case of being determined that the “cancel” button 1003 has not been pressed, the print control processing proceeds to S913.

In S913, the OS 232 determines whether or not the “OK” button 1004 on the simple print setting dialog 1000 has been pressed. In the case of being determined that the “OK” button 1004 on the simple print setting dialog 1000 has not been pressed, the print control processing returns to S902. On the other hand, in the case of being determined that the “OK” button 1004 on the simple print setting dialog 1000 has been pressed, the print control processing proceeds to S914.

In S914, the OS 232 transmits a print job to the printer designated by the user. It should be noted that this print job is a print job generated based on the print setting information that has been determined in S910. When the process of S914 is completed, the print control processing ends.

According to the embodiment described above, the management PC 102 registers the extended application installer 212 in the local application management server 101 in accordance with the settings made on the print management screen 401. The client PC 103 downloads the extended application installer 212 from the local application management server 101. As a result, it is possible to easily provide the extended application installer 212 including the extended application 213 that is a PSA to the client PC 103 used by the user who is not able to access the online application management server 109.

In addition, in the embodiment described above, the local application management server 101 is constructed separately from the print server 108. As a result, it is possible to easily provide the extended application installer 212 to the client PC 103 used by the user who is not able to access the online application management server 109 without increasing the processing load of the print server 108.

It should be noted that in the present embodiment, the local application management server 101 may be constructed to be integrated with the print server 108. As a result, it is possible to easily provide the extended application installer 212 to the client PC 103 used by the user who is not able to access the online application management server 109 without preparing a new server apparatus that functions as the local application management server 101.

In addition, in the present embodiment, the local application management server 101 may be constructed within the management PC 102. As a result, it is possible to easily provide the extended application installer 212 to the client PC 103 used by the user who is not able to access the online application management server 109 by simply preparing the management PC 102.

Furthermore, in the present embodiment, the local application management server 101 and the print server 108 may be constructed within the management PC 102. As a result, it is possible to use the local application management service 211 and the shared print service 241 by simply preparing the management PC 102.

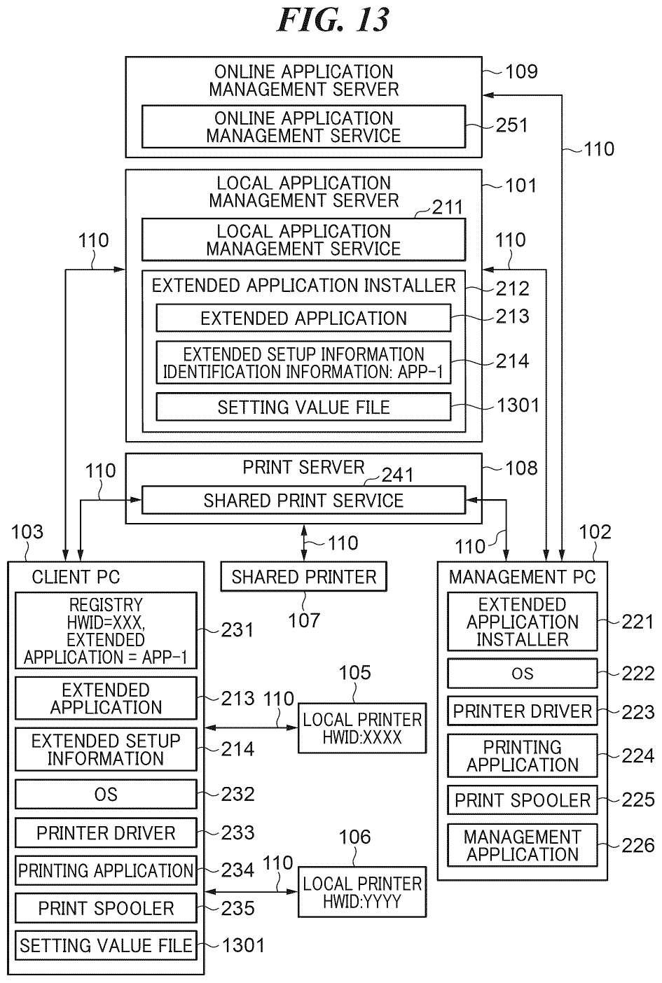

In addition, in the present embodiment, the management PC 102 may perform control that changes the configuration of the extended detailed print setting dialog 1200. It should be noted that since a functional configuration of a printing system that performs such control differs from the above-described functional configuration shown in FIG. 2, the functional configuration thereof will be described with reference to FIG. 13.

FIG. 13 is a block diagram that shows a functional configuration of a printing system that performs the control that changes the configuration of the extended detailed print setting dialog 1200. The functional configuration of the printing system shown in FIG. 13 differs from the functional configuration of the printing system shown in FIG. 2 described above in that the extended application installer 212 that the local application management server 101 obtains from the management PC 102 further includes a setting value file 1301. In addition, the client PC 103 further includes the setting value file 1301 included in the extended application installer 212 that has been obtained from the local application management server 101.

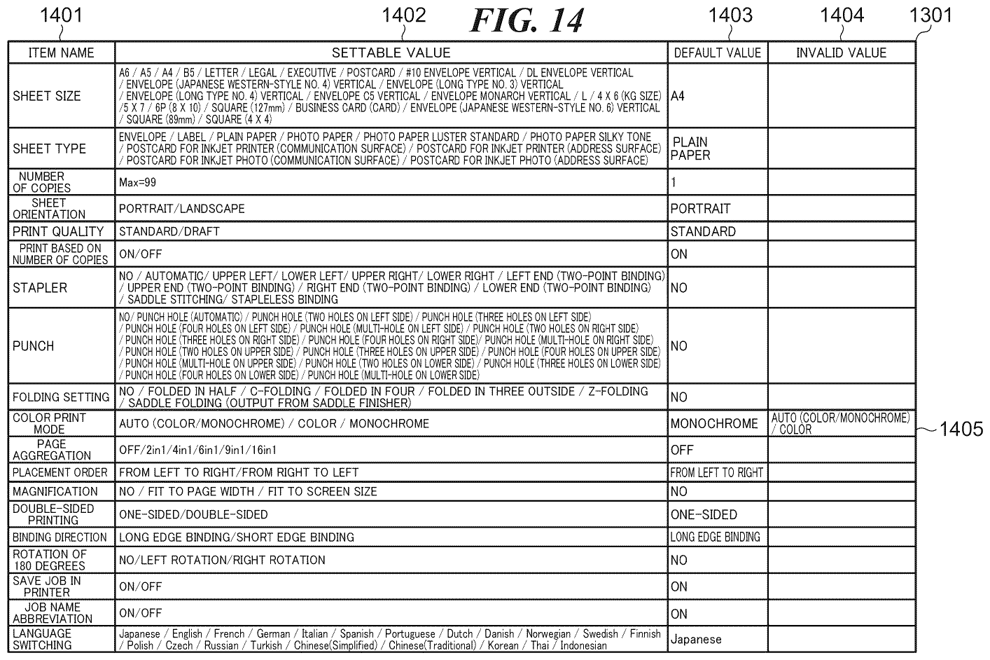

FIG. 14 is a diagram that shows an example of the setting value file 1301 shown in FIG. 13. In the present embodiment, the extended application 213 reads the setting value file 1301 when it is started, and uses setting values included in the setting value file 1301 for display control of the extended detailed print setting dialog 1200.

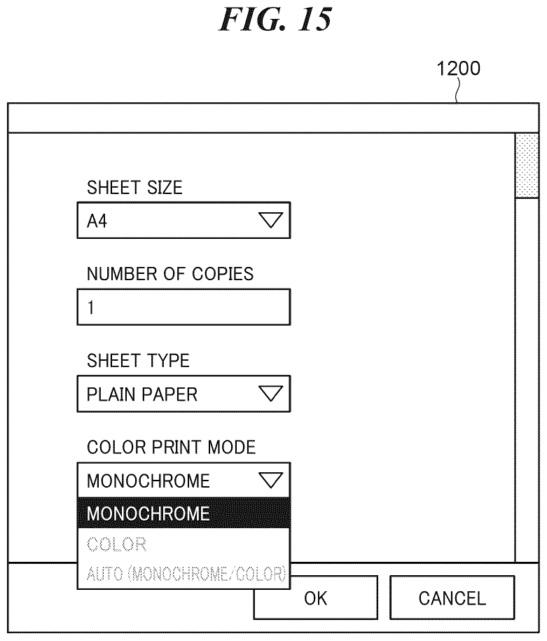

The setting value file 1301 includes an item name 1401, a settable value 1402, a default value 1403, and an invalid value 1404. The item name 1401 is a label name to be displayed on the extended detailed print setting dialog 1200. In the settable value 1402, selectable values for each print setting item included in the extended detailed print setting dialog 1200 have been defined. In the default value 1403, an initial value of each print setting item included in the extended detailed print setting dialog 1200 has been defined. In the invalid value 1404, value(s) that are to be invalid among the values that have been defined in the settable value 1402 have been set. In FIG. 14, as an example, as shown in 1405, “auto (color/monochrome)” and “color” have been set as invalid values of the item name “color print mode”. For example, in the case that the extended application 213 has read the setting value file 1301 that has been set in this way, the extended detailed print setting dialog 1200 that does not allow to select “auto (color/monochrome)” and “color” in the “color print mode” is displayed. On such an extended detailed print setting dialog 1200, for example, as shown in FIG. 15, in the “color print mode”, “auto (color/monochrome)” and “color” are displayed as disabled (grayed out) so that they are not capable of being select-operated.

Next, registration of an installer for an application by the printing system shown in FIG. 13 will be described.

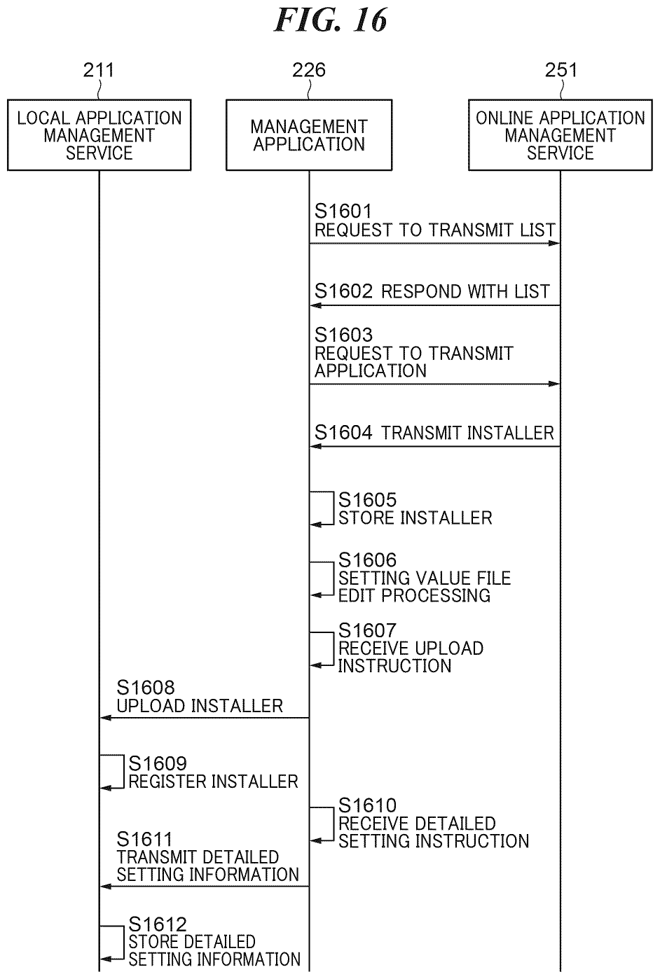

FIG. 16 is a sequence diagram that shows the procedure of a registration processing of an installer for an application executed in the printing system shown in FIG. 13. It should be noted that the registration processing shown in FIG. 16 is similar to the registration processing shown in FIG. 5 described above, and the following will particularly describe the differences from the registration processing shown in FIG. 5 described above. Similar to the registration processing shown in FIG. 5 described above, the registration processing shown in FIG. 16 is also performed by the local application management server 101, the management PC 102, and the online application management server 109. Similar to the registration processing shown in FIG. 5 described above, the registration processing shown in FIG. 16 is also executed, for example, when the administrative user has pressed the control 445 on the print management screen 401 displayed on the display unit 307. When the control 445 is pressed, the management PC 102 accesses the online application management server 109.

As shown in FIGS. 16, S1601 to S1605 that are the same processes as S501 to S505 described above are performed.

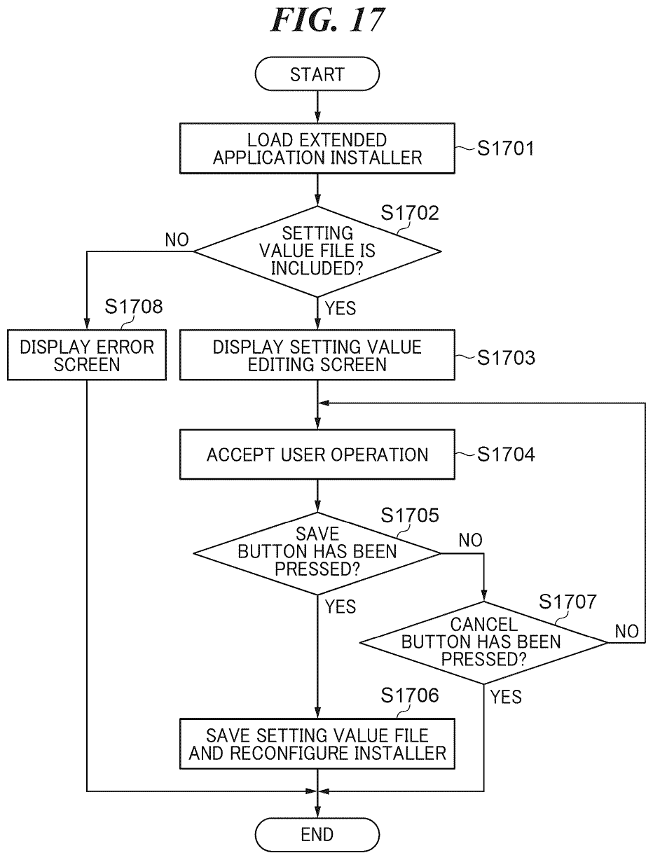

Next, the management application 226 performs a setting value file edit processing shown in FIG. 17, which will be described below (S1606). Next, S1607 to S1612 that are the same processes as S506 to S511 described above are performed, and the registration processing shown in FIG. 16 ends. Through the registration processing shown in FIG. 16, the extended application installer 212 including the setting value file 1301 that has been edited by the administrative user in S1606 is stored in the storage area of the local application management server 101.

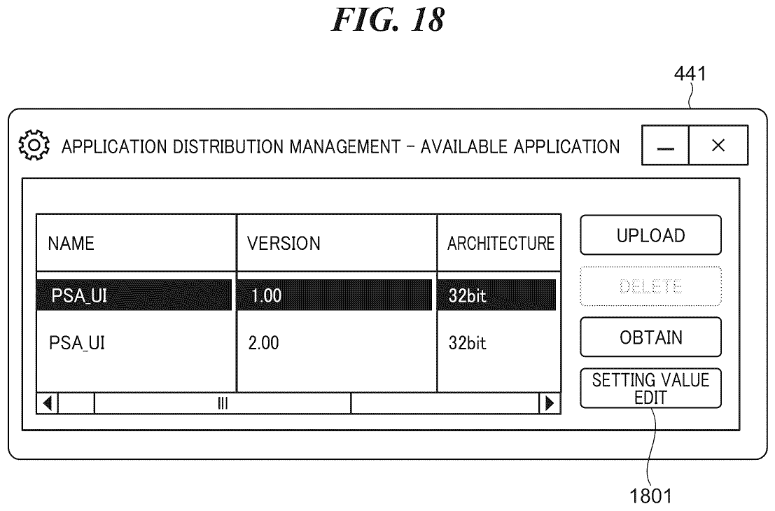

FIG. 17 is a flowchart that shows the procedure of the setting value file edit processing executed in S1606 of FIG. 16. The setting value file edit processing shown in FIG. 17 is executed when the management PC 102 receives an instruction to edit the setting value file (a setting value file editing instruction) from the administrative user. It should be noted that in the present embodiment, the administrative user is able to issue the setting value file editing instruction by pressing a “setting value edit” button 1801 on the sub-dialog 441 shown in FIG. 18. The “setting value edit” button 1801 is a button that is displayed on the sub-dialog 441 when the administrative user has selected one extended application from the list displayed on the control 442.

As shown in FIG. 17, first, the management application 226 loads the extended application installer (S1701). Specifically, the management application 226 takes out, from the storage area, an installer (the extended application installer) for the extended application that has been selected by the administrative user from the list displayed on the control 442, and loads this installer into a working area prepared in advance. For example, extracting a self-extracting file.

Next, the management application 226 determines whether or not the setting value file is included in the loaded extended application installer (S1702). For example, in the case that files extracted from the loaded extended application installer are searched for and a file with a name corresponding to the setting value file (for example, “Setup.INI”) has been found, it is determined that the setting value file is included in the loaded extended application installer. In this case, the setting value file edit processing proceeds to S1703.

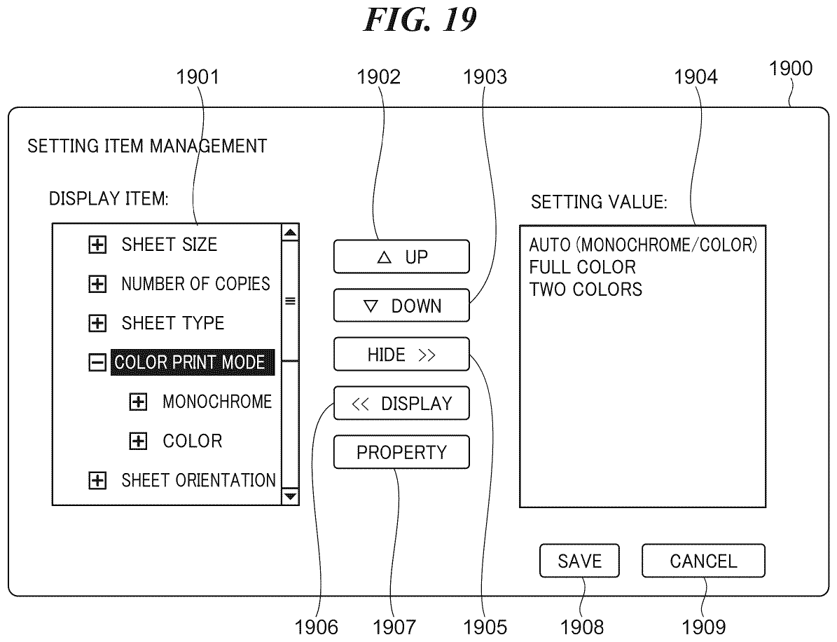

In S1703, the management application 226 causes the display unit 307 to display a setting value editing screen 1900 shown in FIG. 19. The setting value editing screen 1900 is a screen for editing the setting value file included in the installer (the extended application installer) for the extended application that has been selected by the administrative user from the list displayed on the control 442. The setting value editing screen 1900 includes an editing target item selection area 1901, a “move up” button 1902, a “move down” button 1903, a setting value display area 1904, a “hide” button 1905, a “display” button 1906, a “property” button 1907, a “save” button 1908, and a “cancel” button 1909.

On the editing target item selection area 1901, the items displayed on the extended detailed print setting dialog 1200 and the settable values corresponding to each item are displayed in a tree view format. By selecting the displayed items and the displayed settable values and operating various kinds of buttons, the administrative user is able to, for example, change the order of the items displayed on the extended detailed print setting dialog 1200 and change the setting values.

The “move up” button 1902 and the “move down” button 1903 are buttons for changing the display order of the items displayed on the extended detailed print setting dialog 1200 and the display order of the settable values. For example, when the administrative user selects the “move up” button 1902 in a state where “color” displayed on the editing target item selection area 1901 has been selected, “color” moves above “monochrome” on the editing target item selection area 1901. On the extended detailed print setting dialog 1200 based on the setting value file 1301 that has been changed in this way, as the settable values for the “color print mode”, “color” and “monochrome” are displayed in this order.

On the setting value display area 1904, the setting values, which are capable of being added as the settable values corresponding to the item that has been selected on the editing target item selection area 1901, are displayed. For example, when the administrative user selects the “hide” button 1905 in the state where “color” displayed on the editing target item selection area 1901 has been selected, “color” is removed from the editing target item selection area 1901, and “color” is added to the setting value display area 1904. On the extended detailed print setting dialog 1200 based on the setting value file 1301 that has been changed in this way, as the settable values for the “color print mode”, “color” is not displayed, and only “monochrome” is displayed. In addition, when the administrative user selects the “display” button 1906 in a state where “auto (color/monochrome)” displayed on the setting value display area 1904 has been selected, “auto (color/monochrome)” is added to the editing target item selection area 1901, and “auto (color/monochrome)” is removed from the setting value display area 1904. On the extended detailed print setting dialog 1200 based on the setting value file 1301 that has been changed in this way, as the settable values for the “color print mode”, “monochrome”, “color”, and “auto (color/monochrome)” are displayed in this order.

The “property” button 1907 is a button for editing the properties of the item or the settable value that has been selected on the editing target item selection area 1901. When the “property” button 1907 is pressed, a property screen (not shown) is displayed, and on this property screen, for example, the display character string is changed.

The “save” button 1908 is a button for issuing an instruction to save the setting value file 1301 that has been edited on the setting value editing screen 1900. The “cancel” button 1909 is a button for issuing an instruction to discard the edits made by the administrative user on the setting value editing screen 1900.

Returning to FIG. 17, when the management application 226 accepts a user operation on the setting value editing screen 1900 (S1704), the management application 226 determines whether or not the “save” button 1908 has been pressed (S1705).

In the case of being determined in S1705 that the “save” button 1908 has been pressed, the management application 226 saves the setting value file that has been edited on the setting value editing screen 1900 and reconfigures the installer (S1706). Specifically, the management application 226 saves the setting value file that has been edited by the administrative user on the setting value editing screen 1900. In addition, the management application 226 replaces the setting value file of the installer loaded into the working area in S1701 with the already-edited setting value file, and compresses it into a self-extracting installer file. Furthermore, the management application 226 stores the replaced installer in the storage area for the extended application. After that, the setting value file edit processing ends.

In the case of being determined in S1705 that the “save” button 1908 has not been pressed, the management application 226 determines whether or not the “cancel” button 1909 has been pressed (S1707). In the case of being determined that the “cancel” button 1909 has not been pressed, the setting value file edit processing returns to S1704. On the other hand, in the case of being determined that the “cancel” button 1909 has been pressed, the setting value file edit processing ends.

In S1702, in the case that the files extracted from the loaded extended application installer are searched for and a file with a name corresponding to the setting value file (for example, “Setup.INI”) has not been found, it is determined that the setting value file is not included in the loaded extended application installer. In this case, the setting value file edit processing proceeds to S1708. In S1708, the management application 226 displays an error screen on the display unit 307. For example, in the case that an extended application does not support editing of a setting value file, an installer for this extended application does not include the setting value file. In such a case, an error screen including a message such as “not available for editing” is displayed on the display unit 307. After that, the setting value file edit processing ends.

In the embodiment described above, the management PC 102 performs the control that changes the configuration of the extended detailed print setting dialog 1200. As a result, the administrative user is able to operate the management PC 102 to edit the configuration of the extended detailed print setting dialog 1200 to suit the user environment, thereby making the extended detailed print setting dialog 1200 easy to use and suited to the user environment.

Furthermore, in the present embodiment, only installers for extended applications corresponding to printers present in the user environment from among the extended application installers stored in the management PC 102 may be registered in the local application management server 101.

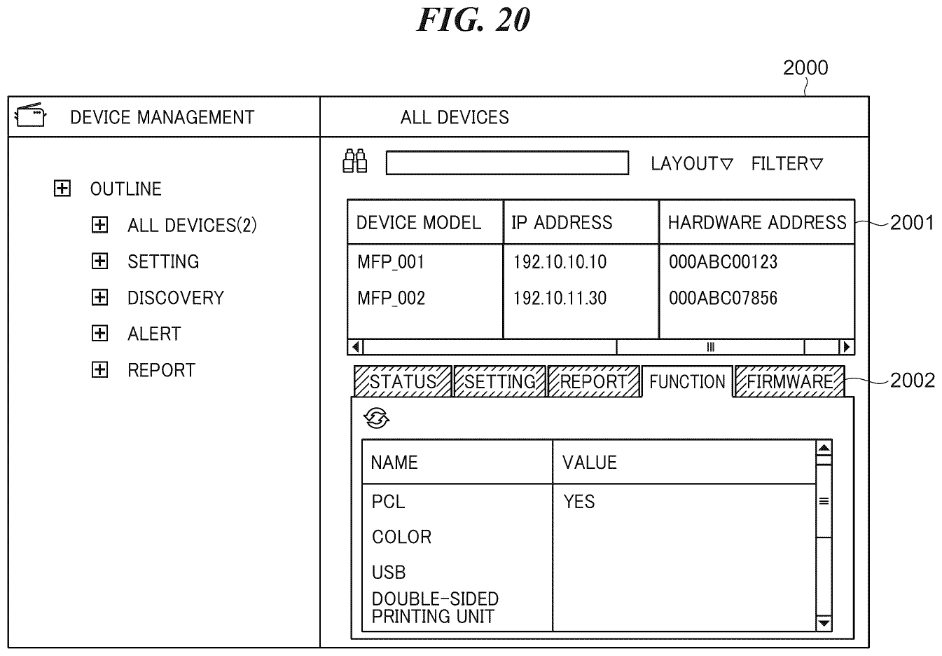

FIG. 20 is a diagram that shows an example of a device management screen 2000 of the management application 226 displayed on the display unit 307 of the management PC 102 shown in FIG. 3. In the present embodiment, the management application 226 obtains and retains information about printers to be managed (printers being management targets). The management application 226 displays the device management screen 2000 on the display unit 307 to provide the administrative user with the information about the printers being the management targets, and accepts various kinds of operations.

The device management screen 2000 includes a printer information display area 2001 and a detailed information display area 2002. On the printer information display area 2001, a list of the information about the printers being the management targets is displayed. The information about the printer (the printer information) includes, for example, a device model of the printer, an IP address, and a hardware address. It should be noted that it is assumed that the device model in the printer information display area 2001 is the same as the HWID. On the detailed information display area 2002, detailed information about the printer that has been selected on the printer information display area 2001 is displayed.

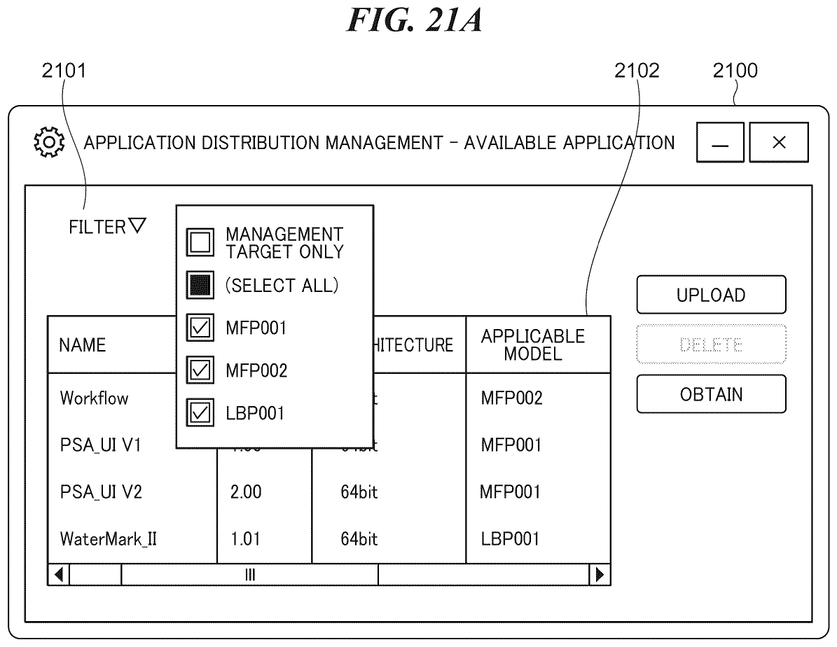

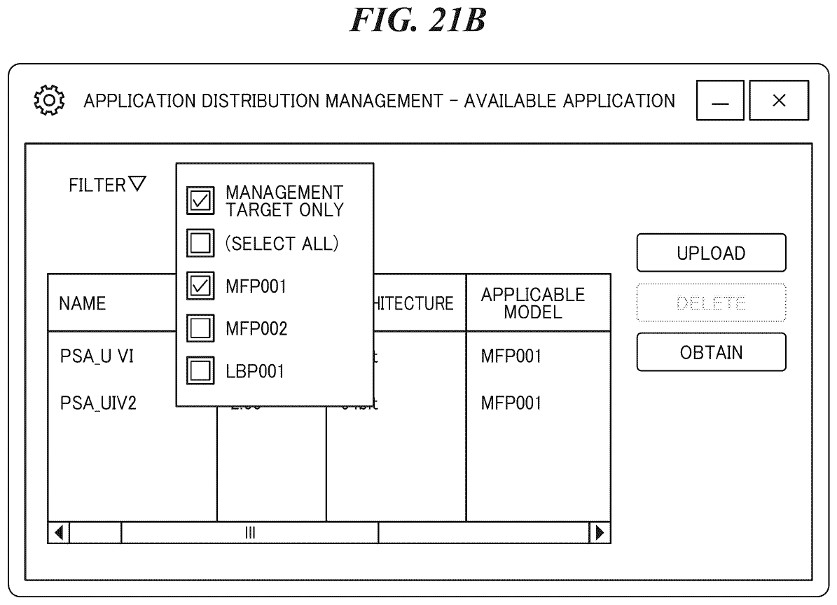

FIG. 21A and FIG. 21B are diagrams that show another example of the sub-dialog 441 on the print management screen 401 shown in FIG. 4. A sub-dialog 2100 shown in FIG. 21A is different from the sub-dialog 441 shown in FIG. 4 described above, and includes a control 2101. The control 2101 has a filter function for narrowing down (filtering) the installers to be registered in the local application management server 101. By this filter function, it is possible to filter the list of the extended applications displayed on a control 2102. By using the control 2101, it is possible to select “management target only” and “select all”, and it is also possible to select an individual model name. In the case that the “management target only” has been selected, on the control 2102, it is filtered to only the extended applications corresponding to the printers that have been managed by the device management function of the management application 226.

For example, it is assumed that the only “MFP_001” is the HWID of the printer present in the user environment. In addition, as shown in FIG. 21A, it is assumed that four installers, which respectively correspond to two extended applications whose applicable models are “MFP_001”, one extended application whose applicable model is “MFP_002”, and one extended application whose applicable model is “LBP_001”, have been stored in the management PC 102. In such a case, when the “management target only” is selected by using the control 2101, as shown in FIG. 21B, a list filtered to only the extended applications whose applicable models are “MFP_001” is displayed on the control 2102. In this way, by being filtered to only the extended applications corresponding to the printers present in the user environment, it is possible to prevent the extended applications that are not capable of being used in the user environment from being registered in the local application management server 101.

In the case that the “select all” has been selected, all the extended applications that have been stored in the management application 226 are displayed on the control 2102. On the individual model name, the model name of the printer that has been managed by the management application 226 is dynamically displayed. In the case that a model has been selected as the individual model name, on the control 2102, it is filtered to only the extended application corresponding to the selected model.

The present invention can also be realized by executing the following processing. In other words, the present invention can also be realized by executing a processing in which software (programs) that implement the functions of the above-described embodiments are supplied to a system or an apparatus via a network or various storage media, and a computer (or a CPU, a MPU, or the like) of the system or the apparatus reads out and executes program codes. In this case, the computer programs and the storage media on which the computer programs have been stored constitute the present invention.

It should be noted that in the present embodiment, the distribution of the application has been described by taking as an example the service having the software distribution function separate from the management application, but the software distribution function may be integrated into the management application.

In addition, in the distribution of the application, although the example, in which waiting until the distribution time arrives, the information about the distributable application is distributed, and the installer is distributed in response to a request received from the client PC, has been described, the present invention is not limited to this example. For example, the present invention can also be applied to a configuration in which the distribution time is not set, or the software is forcibly installed even if there is no request from the client PC.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., ASIC) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-212913, filed on Dec. 18, 2023, which is hereby incorporated by reference herein in its entirety.

What is claimed is:

1. A management apparatus that executes software for managing a printer via a network, the management apparatus comprising:
at least one processor; and
a memory coupled to the processor storing instructions that, when executed by the processor, cause the processor to function as:
a providing unit that provides a setting screen for constructing an application management server on the network; and
a registering unit that registers an installer in the application management server in accordance with settings made on the setting screen, and
wherein the installer is an installer for an application for extending an in-box driver that has been installed in a client apparatus to use the printer, and
the client apparatus downloads the installer from the application management server.

2. The management apparatus according to claim 1, wherein
the processor is caused to further function as a communication unit that communicates with a print server that accepts a print instruction and print data from outside, and
the application management server is constructed separately from the print server.

3. The management apparatus according to claim 1, wherein
the processor is caused to further function as a communication unit that communicates with a print server that accepts a print instruction and print data from outside, and
the application management server is constructed to be integrated with the print server.

4. The management apparatus according to claim 1, wherein
the application management server is constructed within the management apparatus.

5. The management apparatus according to claim 1, wherein
the application management server and a print server that accepts a print instruction and print data from outside are constructed within the management apparatus.

6. The management apparatus according to claim 1, wherein
the processor is caused to further function as
an obtaining unit that obtains the installer from a public server that provides the installer via the Internet; and
a retaining unit that retains installers that have been obtained from the public server.

7. The management apparatus according to claim 6, wherein
the processor is caused to further function as a narrowing-down unit that narrows down installers to be registered in the application management server from among the retained installers.

8. The management apparatus according to claim 7, wherein
the narrowing-down unit narrows down the installers to be registered in the application management server to an installer for an application corresponding to the printer.

9. The management apparatus according to claim 1, wherein
the processor is caused to further function as an editing unit that edits a configuration of a setting screen of the application corresponding to the installer.

10. A control method for a management apparatus that executes software for managing a printer via a network,
the control method comprising:
a providing step of providing a setting screen for constructing an application management server on the network; and
a registering step of registering an installer in the application management server in accordance with settings made on the setting screen, and
wherein the installer is an installer for an application for extending an in-box driver that has been installed in a client apparatus to use the printer, and
the client apparatus downloads the installer from the application management server.

11. A non-transitory computer-readable storage medium storing a program for causing a computer to execute a control method for a management apparatus that executes software for managing a printer via a network,
the control method comprising:
a providing step of providing a setting screen for constructing an application management server on the network; and
a registering step of registering an installer in the application management server in accordance with settings made on the setting screen, and
wherein the installer is an installer for an application for extending an in-box driver that has been installed in a client apparatus to use the printer, and
the client apparatus downloads the installer from the application management server.
